(19) United States
(12) Patent Application Publication
(10) Pub. No.: US 2026/0045616 A1
(43) Pub. Date: Feb. 12, 2026

(54) HIGH-VOLTAGE DIRECT CURRENT BATTERY SYSTEM WITH LOW-VOLTAGE STORAGE MODULE

(71) Applicant: SAFRAN ELECTRICAL & POWER, Blagnac Cedex (FR)

(72) Inventors: Guillaume Cherouvrier, Moissy-Cramayel (FR); Sophie Boudau, Moissy-Cramayel (FR); Philippe Naneix, Moissy-Cramayel (FR)

(73) Assignee: SAFRAN ELECTRICAL & POWER, Blagnac Cedex (FR)

(21) Appl. No.: 19/140,085

(22) PCT Filed: Dec. 1, 2023
(86) PCT No.: PCT/FR2023/051886

§ 371 Date: Jun. 17, 2025

(30) Foreign Application Priority Data
Dec. 21, 2022 (FR) 2214081

(51) Int. Cl. H01M 50/249; B64D 27/357; H01M 50/298

(52) U.S. Cl. CPC H01M 50/249; B64D 27/357; H01M 50/298; H01M 2220/20

(57) ABSTRACT

This system comprises one of the battery modules coupled to at least one control device and formed of battery cells arranged in parallel coherent strings of battery cells, the battery modules being distributed in two independent networks including a high-voltage network and a low-voltage network coupled in series, the low-voltage network including a battery module including a first sub-network and a second sub-network electrically separated from the first sub-network by a physical separation element arranged on the battery module of said low-voltage network, characterised in that each battery module of the high-voltage network includes a number of parallel coherent strings of battery cells equal to the number of parallel coherent strings of battery cells of each battery module of the first sub-network.

### TECHNICAL FIELD

The present invention relates to electricity storage and supply systems, in particular in vehicles using battery-type storage elements that constitute the only energy source available for all on-board equipment.

In particular, the present invention is intended to provide a hybrid storage system for electrically propelled aircraft platforms that can combine low-voltage and high-voltage output.

### PRIOR ART

Electric propulsion for conventional take-off and landing (CTOL) aircraft or new mobility vertical take-off and landing (VTOL) aircraft requires high electrical power that, for reasons of optimising power-to-weight ratios, motor efficiency and wiring mass, operate at high-voltage direct current (HVDC) levels between six hundred volts and eight hundred volts.

This electrical power is supplied by HVDC batteries sized to provide sufficient power to ensure an aircraft flight mission with the necessary safety margin.

These batteries consist of battery cells coupled in series and in parallel coherent strings to obtain the expected characteristics.

To fit into the confined spaces of an aircraft and be compatible with handling operations and personnel safety, the batteries include modular battery modules. The modules include battery cells arranged in series on the one hand to provide the desired voltage as the sum of the individual voltages of each battery cell in series, and arranged on the other hand in parallel coherent strings of cells in series to obtain the desired current or capacity in ampere-hours as the sum of the currents or capacities of each parallel string.

Management of the state of charge and balancing of the cells is carried out by an electronic device that manages the energy between the different cells so that they are electrically balanced in terms of their state of charge, voltage and temperature.

These assemblies are commonly used as described in the following documents: EP2932574B1, EP3694015A1, US20220140409A1 or EP2452391B1.

However, with these known systems, the low-voltage needed for an aircraft's navigation equipment is either provided by dedicated low-voltage batteries that have limited capacity, meaning that they may not provide the necessary energy for the entire duration of a flight, or by converters placed between the main high-voltage batteries for electric propulsion, which run the risk of propagating high-voltage currents to low-voltage equipment which could be destroyed by this voltage level in the event of a failure.

Furthermore, it is known to use a solution for drawing electrical power at an intermediate point in the cell assembly of high-voltage DC batteries at a low-voltage level, but this requires there to be an identical number of parallel channels in the cell assemblies or modules which are connected in series for the correct management of the battery cells, which is not disclosed in the current prior art.

### DISCLOSURE OF THE INVENTION

The Applicant constantly strives to reduce its negative environmental impact by using environmentally-friendly development and manufacturing methods and processes that minimise greenhouse gas emissions as much as possible to reduce the environmental footprint of its business.

This sustained research and development work focuses on new generations of aircraft engines, making aircraft lighter, in particular through the materials used and lighter on-board equipment, developing the use of electrical technologies to ensure propulsion, and, as an essential complement to technological progress, aviation biofuels.

To this end, the invention is the result of technological research aimed at significantly improving the performance of aeroplanes and, accordingly, contributes to reducing the environmental impact of aeroplanes.

The object of the invention is to overcome at least some of the aforementioned drawbacks and propose a storage system capable of combining the advantages of speed, simplicity and reliability for its implementation, by delivering low-voltage and high-voltage direct current.

In view of the above, the object of the invention is a hybrid high-voltage and low-voltage DC battery system, including battery modules coupled to at least one control device and formed of battery cells arranged in parallel coherent strings of battery cells, the battery modules being distributed in two independent networks including a high-voltage network and a low-voltage network coupled in series, the low-voltage network including a battery module including a first sub-network and a second sub-network electrically separated from the first sub-network by a physical separation element arranged on the battery module of said low-voltage network, each battery module of the high-voltage network including a number of parallel coherent strings of battery cells equal to the number of parallel coherent strings of battery cells of each battery module of the first sub-network.

Preferably, the high-voltage network and the low-voltage network are each coupled to and controlled by a separate dedicated control device.

For example, the battery cells are adapted to be able to deliver a capacity between five and twenty ampere-hours.

Advantageously, each battery module fits into a parallelepiped having a height of between one hundred and eight and one hundred and twenty-eight millimetres, a width of between three hundred and twenty-one and three hundred and thirty-one millimetres, and a length of between three hundred and eighty-three and four hundred and three millimetres.

According to one embodiment, the battery modules of the high-voltage network and the first sub-network are formed of the same number of battery cells, this number being an integer multiple of the number of parallel coherent strings of battery cells of the first sub-network.

In one embodiment, the battery modules each include ninety-six battery cells, the high-voltage network includes seven battery modules coupled in series and the low-voltage network includes a battery module that includes the first and second electrically separated sub-networks, the physical separation element being configured so that the first sub-network comprises four parallel coherent strings of twelve battery cells so that, on the one hand, the second sub-network includes eight parallel coherent strings of twelve battery cells and, on the other hand, the modules of the high-voltage network include four parallel coherent strings of twenty-four battery cells.

Advantageously, the battery modules each include ninety-six battery cells, the high-voltage network includes seven battery modules coupled in series and the low-voltage network includes a battery module that includes the first and second electrically separated sub-networks, the physical separation element being configured so that the first sub-network comprises four parallel coherent strings of eight battery cells so that, on the one hand, the second sub-network includes eight parallel coherent strings of eight battery cells and, on the other hand, the modules of the high-voltage network include four parallel coherent strings of twenty-four battery cells.

The system may further provide that the battery modules each include ninety-six battery cells, the high-voltage network including five battery modules coupled in series and the low-voltage network including a battery module that includes the first and second electrically separated sub-networks, the physical separation element being configured so that the first sub-network comprises three parallel coherent strings of twelve battery cells so that, on the one hand, the second sub-network includes five parallel coherent strings of twelve battery cells and, on the other hand, the modules of the high-voltage network include three parallel coherent strings of thirty-two battery cells.

The system is preferably adapted to fit in a parallelepiped having a height and a length of between four hundred and fifty and five hundred millimetres, and a width of between six hundred and fifty and six hundred and ninety millimetres.

The invention also relates to an aircraft including a system as described above.

### BRIEF DESCRIPTION OF THE DRAWINGS

The invention will be better understood from the detailed study of some embodiments considered as non-limiting examples and illustrated by the appended drawings, wherein:

FIG. 1 shows a battery system according to a first particular embodiment.

FIG. 2 shows a second embodiment of the battery system.

FIG. 3 shows a housing for the battery module.

FIG. 4 shows the battery modules coupled to an aircraft engine.

FIG. 5 shows a first view of the installation of the system in an aircraft.

FIG. 6 shows a second view of the installation of the system in an aircraft.

### DETAILED DESCRIPTION

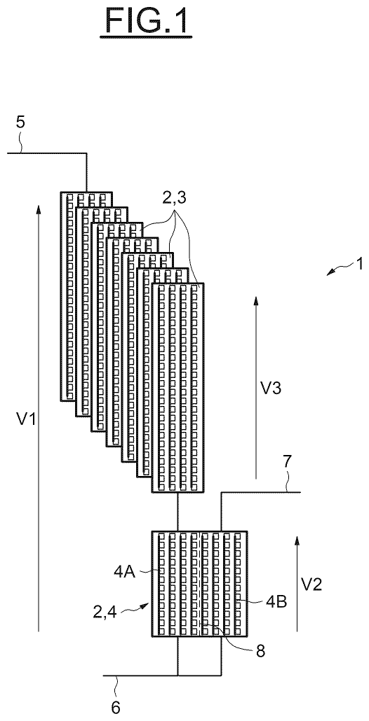

In the first embodiment shown in FIG. 1, the hybrid high-voltage and low-voltage DC battery system 1 includes battery modules 2 coupled to at least one control device and formed of battery cells arranged in parallel coherent strings of battery cells.

The battery modules 2 are distributed in two independent networks including a high-voltage network 3 and a low-voltage network 4 coupled in series.

The low-voltage network 4 includes a battery module 2 including a first sub-network 4A and a second sub-network 4B electrically separated from the first sub-network 4A by a physical separation element 8 arranged on the battery module 2 of said low-voltage network 4.

Each battery module 2 of the high-voltage network 3 includes a number of parallel coherent strings of battery cells equal to the number of parallel coherent strings of battery cells of each battery module 2 of the first sub-network 4A.

Thus, the system benefits from the structuring of the battery modules 2 to form, on the one hand, the assembly of the high-voltage battery network 4A, used in particular for propulsion in an aircraft, and, on the other hand, a dedicated and segregated assembly formed by the low-voltage network 4B to supply the low-voltage equipment of this aircraft.

Thus, using battery modules 2 consisting of a defined number of battery cells arranged in series in parallel strings of each module 2 to have the desired voltage level V3 and the expected capacity in ampere-hours between the input of the high-voltage network 6 and the outputs 5,7 of the low-voltage network 4, it is possible to easily define the strings in each module 2. The physical separation element arranged between the first and second sub-networks 4A,4B of cells of the battery module 2 forming the low-voltage network 4 is provided to prevent any fault propagation from one sub-network 4A,4B to the other, as well as to form an electrical interface in order to both be able to output sufficient propulsion power from the first sub-network 4A and independently connect the non-propulsion power to the various consumers thanks to the second sub-network 4B.

Furthermore, the high-voltage network 3 and the low-voltage network 4 can each be coupled to a separate dedicated control device and controlled thereby.

In particular, a control device dedicated only to the first sub-network 4A may be provided.

This makes it possible to monitor the voltages V2 and currents of the first 4A sub-network, to manage the correct balancing of its battery cells.

For example, the battery cells are adapted to be able to deliver a capacity between five and twenty ampere-hours.

The voltage, capacity and current performance of the cells are characteristic of their chemistry.

Thus, assuming a cell voltage of four point two volts, the capacity is in the order of five ampere-hours to twenty ampere-hours, typically ten ampere-hours.

Assuming a structure of the battery module 2 with ninety-six cells, an assembly of twenty-four cells in series and four coherent strings in parallel for the high-voltage network 3, a battery module 2 of the high-voltage network 3 is produced delivering a voltage V3 of one hundred volts and having a capacity of forty ampere-hours.

In the first embodiment, the high-voltage network 3 further includes seven battery modules 2 coupled in series and the low-voltage network 4 includes a battery module 2 that includes the first and second electrically separated sub-networks 4A, 4B, the physical separation element 8 being configured so that the first sub-network 4A comprises four parallel coherent strings of twelve battery cells so that, on the one hand, the second sub-network 4B includes eight parallel coherent strings of twelve battery cells and, on the other hand, the modules of the high-voltage network 4A include four parallel coherent strings of twenty-four battery cells.

Thus, the low-voltage network 4 includes twelve cells in series of eight coherent chains in parallel, which enables its module 2 to deliver a voltage V2 of fifty volts and a capacity of eighty ampere-hours.

By dividing said module 2 of the low-voltage network 4 into two battery cell sub-networks 4A,4B thanks to the physical separation element 8, the first and second electrically separated sub-networks 4A,4B are produced, each with fifty volts and forty ampere-hours.

The advantage of this structuring of the battery modules 2 is to have a high-voltage network 3 configured to have a voltage V3 of seven hundred and fifty volts with a capacity of forty ampere-hours for electric propulsion, with a coherent string of four strings of battery cells in parallel whose balancing is ensured by the control device dedicated only to the first sub-network 4A, and a battery pack configured to have a voltage V2 of fifty volts and forty ampere-hours which can be managed by a second control device and is dedicated to supplying the low-voltage equipment.

For example, the battery modules 2 of the high-voltage network 3 and the first sub-network 4A are formed of the same number of battery cells, this number being an integer multiple of the number of parallel coherent strings of battery cells of the first sub-network 4A.

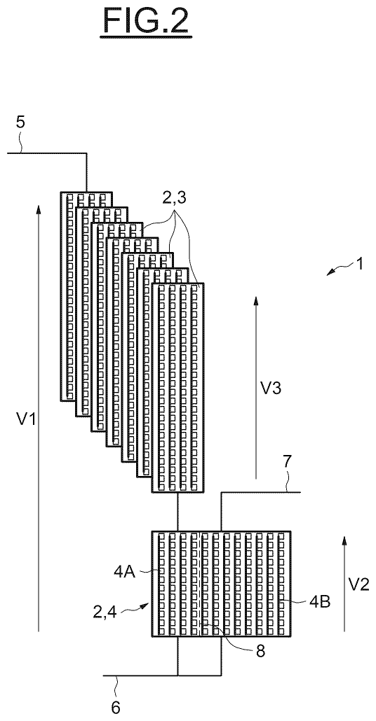

In a second embodiment shown in FIG. 2, the battery modules 2 each include ninety-six battery cells, the high-voltage network 3 includes seven battery modules 2 coupled in series and the low-voltage network 4 includes a battery module 2 that includes the first and second electrically separated sub-networks 4A,4B, the physical separation element 8 being configured so that the first sub-network 4A comprises four parallel coherent strings of eight battery cells so that, on the one hand, the second sub-network 4B includes eight parallel coherent strings of eight battery cells and, on the other hand, the modules of the high-voltage network 4A include four parallel coherent strings of twenty-four battery cells.

Thus, the second embodiment of the system 1 is slightly different from the first embodiment in that the low-voltage network 4 includes a module 2 of the low-voltage network 4 having eight battery cells in series and twelve coherent strings in parallel delivering a voltage V2 of thirty-three volts for one hundred and twenty ampere-hours.

In the second embodiment, the first and second sub-networks 4A,4B are configured to be able to deliver a voltage V2 of thirty-three volts and forty ampere-hours, respectively, to be consistent with the high-voltage string, and eighty ampere-hours, for the low-voltage loads.

The advantage of this structuring of the battery modules 2 of the second embodiment makes it possible to have a high-voltage battery pack configured to have a voltage V3 of seven hundred and forty volts having a capacity of forty ampere-hours for the electric propulsion, with a coherent string of four strings of cells in parallel that can be managed by the first control device to ensure balancing and monitoring, and a battery pack configured to have a voltage V2 of thirty-three volts having a capacity of eighty ampere-hours, which is coherent and can be managed by a second control device to supply the low-voltage equipment.

This voltage V2 of thirty-three volts for low-voltage equipment is consistent with the regulatory voltage range of the aeronautical standard “DO160” for which it is designed and qualified.

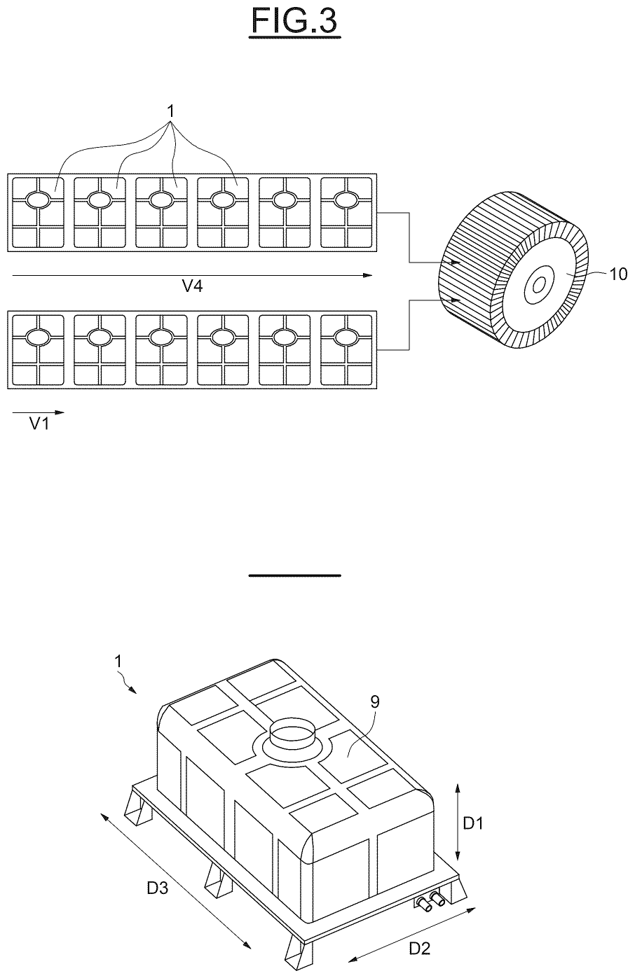

FIGS. 3 and 4 show that each battery module 2 can, for example, fit into a parallelepiped having a height D1 of between one hundred and eight and one hundred and twenty-eight millimetres, a width D2 of between three hundred and twenty-one and three hundred and thirty-one millimetres, and a length D3 of between three hundred and eighty-three and four hundred and three millimetres, which means that these modules 2 are very compact and can be installed uniformly in the aircraft to the extent that they have the same dimensions and can therefore be integrated into identical housings 9.

In a third embodiment, the battery modules 2 each include ninety-six battery cells, the high-voltage network 3 includes five battery modules 2 coupled in series and the low-voltage network 4 includes a battery module 2 that includes the first and second electrically separated sub-networks 4A,4B, the physical separation element 8 being configured so that the first sub-network 4A comprises three parallel coherent strings of twelve battery cells so that, on the one hand, the second sub-network 4B includes five parallel coherent strings of twelve battery cells and, on the other hand, the modules of the high-voltage network 4A include three parallel coherent strings of thirty-two battery cells.

For an electric propulsion system with battery cells with four point two volts and a capacity of five ampere-hours per cell, the third embodiment includes six battery modules 2 in series consisting of five modules 2 that deliver a voltage V3 of one hundred and thirty-four volts each and sixty ampere-hours, as well as a battery module 2 which delivers a voltage V2 of fifty volts, the first sub-network 4A of which has a capacity of sixty ampere-hours for the propulsion system and the second sub-network 4B of which has a capacity of one hundred ampere-hours for the avionics.

The assembly thus composed of six geometrically identical battery modules 2 produces a high-voltage battery for the aircraft propulsion system delivering a voltage V3 of seven hundred and twenty-two volts and sixty ampere-hours and a low-voltage battery for the avionics delivering a voltage V2 of fifty volts and one hundred ampere-hours.

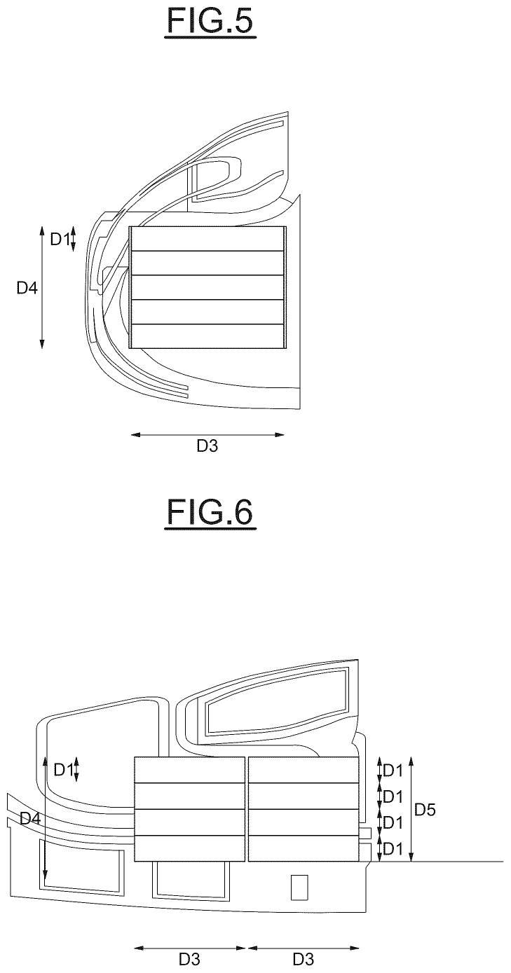

As shown in FIGS. 5 and 6, the system may be adapted to fit in a parallelepiped having a height D5 and a length D4 of between four hundred and fifty and five hundred millimetres, and a width of between six hundred and fifty and six hundred and ninety millimetres.

Thanks to the identical dimensions of the six battery modules 2 described above, installation on an aircraft is facilitated by the uniformity of the housings 9 in the areas dedicated to the electrical energy storage elements of the aircraft, in particular electric propulsion aircraft which only have this type of energy on board to ensure both the supply of the propulsion members 10 and the supply of the navigation equipment (avionics, radio, lighting, etc.).

The invention therefore also relates to an aircraft including a system 1 as described above.

Thus, a high-voltage battery system 1 is produced for electric propulsion, making it possible to provide low-voltage energy to power low-voltage navigation equipment, and wherein the battery cells assembled in each battery module 2 are managed by the corresponding dedicated control devices as if they were independent batteries but integrated into identical mechanical structures, thanks to parallel coherent cell strings from the battery module assemblies 2.

These strings make it possible to have physically and functionally independent channels managed independently between high-voltage and low-voltage equipment, which ensures that there can be no high-voltage propagation onto low-voltage circuits and equipment.

1. Hybrid high-voltage and low-voltage DC battery system,
including battery modules coupled to at least one control device and formed of battery cells arranged in parallel coherent strings of battery cells, the battery modules being distributed in two independent networks including a high-voltage network and a low-voltage network coupled in series, the low-voltage network including a battery module including a first sub-network and a second sub-network electrically separated from the first sub-network by a physical separation element arranged on the battery module of said low-voltage network, wherein each battery module of the high-voltage network includes a number of parallel coherent strings of battery cells equal to the number of parallel coherent strings of battery cells of each battery module of the first sub-network.

2. System according to claim 1, wherein the high-voltage network and the low-voltage network are each coupled to and controlled by a separate dedicated control device.

3. System according to claim 1, wherein the battery cells are adapted to be able to deliver a capacity between five and twenty ampere-hours.

4. System according to claim 1, wherein each battery module fits into a parallelepiped having a height of between one hundred and eight and one hundred and twenty-eight millimetres, a width of between three hundred and twenty-one and three hundred and thirty-one millimetres, and a length of between three hundred and eighty-three and four hundred and three millimetres.

5. System according to claim 1, wherein the battery modules of the high-voltage network and the first sub-network are formed of the same number of battery cells, this number being an integer multiple of the number of parallel coherent strings of battery cells of the first sub-network.

6. System according to claim 1, wherein the battery modules each include ninety-six battery cells, the high-voltage network includes seven battery modules coupled in series and the low-voltage network includes a battery module that includes the first and second electrically separated sub-networks, the physical separation element being configured so that the first sub-network comprises four parallel coherent strings of twelve battery cells so that, on the one hand, the second sub-network includes eight parallel coherent strings of twelve battery cells and, on the other hand, the modules of the high-voltage network include four parallel coherent strings of twenty-four battery cells.

7. System according to claim 1, wherein the battery modules each include ninety-six battery cells, the high-voltage network includes seven battery modules coupled in series and the low-voltage network includes a battery module that includes the first and second electrically separated sub-networks, the physical separation element being configured so that the first sub-network comprises four parallel coherent strings of eight battery cells so that, on the one hand, the second sub-network includes eight parallel coherent strings of eight battery cells and, on the other hand, the modules of the high-voltage network include four parallel coherent strings of twenty-four battery cells.

8. System according to claim 1, wherein the battery modules each include ninety-six battery cells, the high-voltage network includes five battery modules coupled in series and the low-voltage network includes a battery module that includes the first and second electrically separated sub-networks, the physical separation element being configured so that the first sub-network comprises three parallel coherent strings of twelve battery cells so that, on the one hand, the second sub-network includes five parallel coherent strings of twelve battery cells and, on the other hand, the modules of the high-voltage network include three parallel coherent strings of thirty-two battery cells.

9. System according to claim 1, adapted to fit in a parallelepiped having a height and a length of between four hundred and fifty and five hundred millimetres, and a width of between six hundred and fifty and six hundred and ninety millimetres.

10. Aircraft including a system according to claim 1.
